(19) United States
(12) Patent Application Publication
(10) Pub. No.: US 2015/0005010 A1
(43) Pub. Date: Jan. 1, 2015

(54) METHOD AND APPARATUS FOR MANAGING THE PRESENTING OF LOCATION-BASED EVENTS

(71) Applicants: Fei Zhang, Beijing (CN); Bing Dai, Beijing (CN); Xuguang Tian, Beijing (CN); Jingang Sun, Beijing (CN); Qian Xu, Beijing (CN)

(72) Inventors: Fei Zhang, Beijing (CN); Bing Dai, Beijing (CN); Xuguang Tian, Beijing (CN); Jingang Sun, Beijing (CN); Qian Xu, Beijing (CN)

(73) Assignee: NOKIA CORPORATION, Espoo (FI)

(21) Appl. No.: 14/241,418

(22) PCT Filed: Aug. 30, 2011
(86) PCT No.: PCT/CN2011/079103

§ 371 Date: Feb. 26, 2014

(51) Int. Cl. H04W 4/02

(52) U.S. Cl. CPC H04W 4/023
USPC 455/456.3

(57) ABSTRACT

An approach is provided for managing the presenting of information related to location-based events. A location-based event platform determines to associate at least one location-based event with one or more geographic locations. An aggregation of information associated with the at least one location-based event is caused. The location based event platform also causes, at least in part, a presentation of at least a portion of the information at a device, based at least in part, on location information of the device with respect to the one or more geographic locations.

### BACKGROUND

Service providers and device manufacturers (e.g., wireless, cellular, etc.) are continually challenged to deliver value and convenience to consumers by, for example, providing compelling network services. One area of interest has been development of location-based services that are provided to users via devices and/or via a communication network (e.g., the Internet). For example, social location sharing services are becoming are a popular way for users to share their previous/current locations (e.g., restaurants, bars, etc.) and related experiences with their friends, family, coworkers, etc. It is further noted that users, service providers and merchants are seeking new ways to use such location-based data and services to, for instance publish details regarding events of interest, advertisements and promotions (e.g., coupons, discounts, etc.). Unfortunately, users are limited in their ability to leverage location information for one or more device users to affect the presentment of information related to events.

### SOME EXAMPLE EMBODIMENTS

Therefore, there is a need for an approach for managing the presenting of information related to location-based events.

According to one embodiment, a method comprises determining to associate at least one location-based event with one or more geographic locations. The method also comprises causing, at least in part, an aggregation of information associated with the at least one location-based event. The method further comprises causing, at least in part, a presentation of at least a portion of the information at a device, based at least in part, on location information of the device with respect to the one or more geographic locations.

According to another embodiment, an apparatus comprises at least one processor, and at least one memory including computer program code for one or more computer programs, the at least one memory and the computer program code configured to, with the at least one processor, cause, at least in part, the apparatus to determine to associate at least one location-based event with one or more geographic locations. The apparatus is also caused to aggregate information associated with the at least one location-based event. The apparatus is further caused to present at least a portion of the information at a device, based at least in part, on location information of the device with respect to the one or more geographic locations.

According to another embodiment, a computer-readable storage medium carries one or more sequences of one or more instructions which, when executed by one or more processors, cause, at least in part, an apparatus to determine to associate at least one location-based event with one or more geographic locations. The apparatus is also caused to aggregate information associated with the at least one location-based event. The apparatus is further caused to present at least a portion of the information at a device, based at least in part, on location information of the device with respect to the one or more geographic locations.

According to another embodiment, an apparatus comprises means for determining to associate at least one location-based event with one or more geographic locations. The apparatus also comprises means for causing, at least in part, an aggregation of information associated with the at least one location-based event. The apparatus further comprises means for causing, at least in part, a presentation of at least a portion of the information at a device, based at least in part, on location information of the device with respect to the one or more geographic locations.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-24 and 42-44.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1A is a diagram of a system capable of managing the presenting of information related to location-based events, according to one embodiment;

FIG. 1B is a diagram of proximity regions for affecting operation of the location-based event platform, according to one embodiment.

FIG. 2 is a diagram of the components of a location-based event platform, according to one embodiment;

FIGS. 3A-3D are flowcharts of a process for managing the presenting of information related to location-based events, according to various embodiments;

FIGS. 4A-4C are diagrams of user interfaces utilized in the processes of FIGS. 3A-3D, according to various embodiments;

FIG. 5 is a diagram of hardware that can be used to implement an embodiment of the invention;

FIG. 6 is a diagram of a chip set that can be used to implement an embodiment of the invention; and

FIG. 7 is a diagram of a mobile terminal (e.g., handset) that can be used to implement an embodiment of the invention.

### DESCRIPTION OF SOME EMBODIMENTS

A method and apparatus for managing the presenting of information related to location-based events is disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

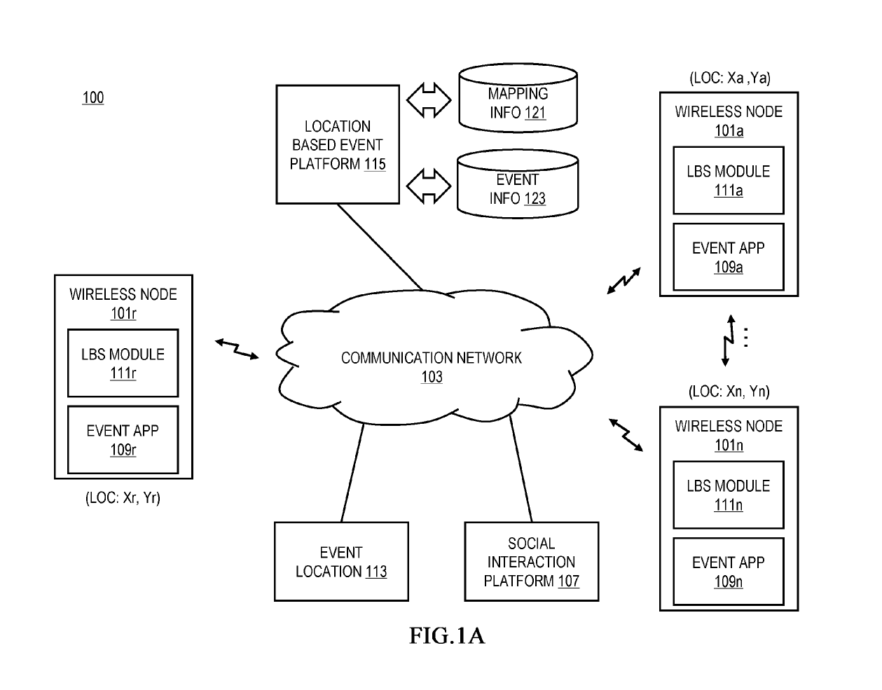

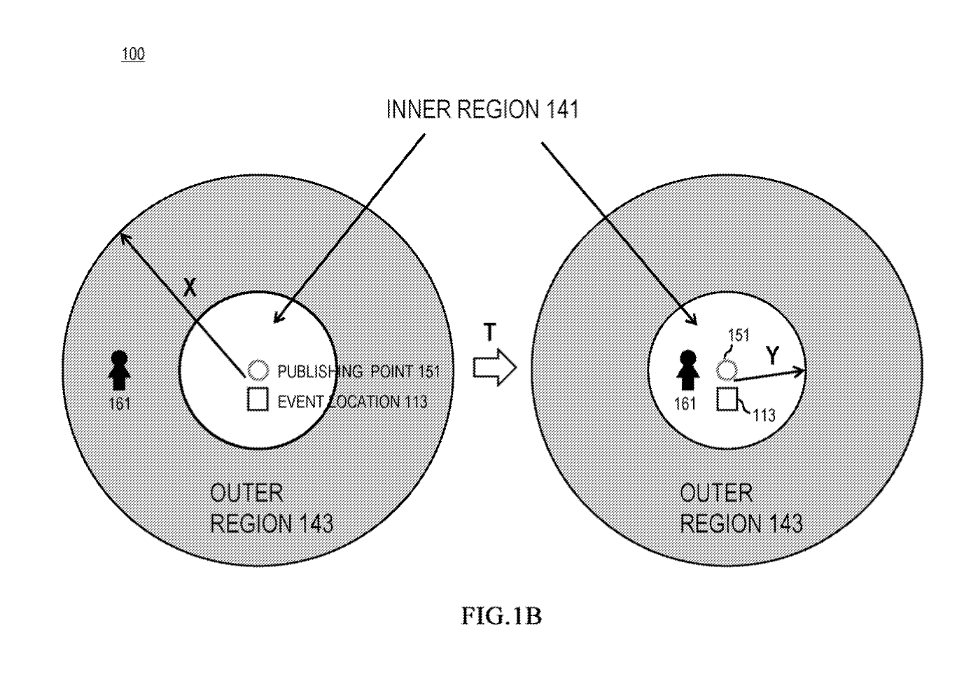

FIG. 1A is a diagram of a communication system capable of managing the presenting of information related to location-based events, according to an exemplary embodiment. By way of example, the system 100 enables one or more user devices users, i.e., wireless nodes 101a-101r to post, publish and share information regarding events associated with a specific location 113. The system includes location-based event platform 115 that interacts with the respective wireless nodes 101a-101r to enable at least one of the nodes to disseminate information to the other nodes based on a determined gradual increase in proximity of the other nodes to the event location 113, the at least one node that generated the information, or a combination thereof. Proximity changes are determined by the location-based event platform 115 based, at least in part, on the persistent tracking of location information of the respective nodes 101a-101r.

Location information may include, for example, any information for indicating the location of a user, node or other item within a given environment. By way of example, location information may be determined based on global positioning system (GPS) techniques, local positioning system (LPS) techniques, or a combination thereof. The location information may be determined in connection with one or more nodes 101a-101r whose location and/or presence is required for supporting mutual interaction within a given proximity. By way of example, the location information may be determined, generated or presented in the form of specific coordinates indicating a geographic reference point/location for a given node 101a-101r, i.e., coordinates (Xa, Ya) through (Xr, Yr) representing respective latitude and longitude data. In addition, the location information may be determined, generated or presented with respect to a given event location 113, as mapping information 121 generated in accord with a mapping application, in connection with text such as a postal address location, in connection with social networking data (e.g., message threads), or a combination thereof. As will be discussed further later on, location information may be analyzed and/or processed with respect to information 123 regarding one or more events or notifications thereof.

A particular area of interest to service providers, retailers, event promoters, and the like is the provision of tools for combining social networking and location-based services (LBS), as a means of enabling device users to take advantage of the full range of capabilities of their mobile devices. A location-based service (LBS) refers to any information service, application or module accessible through a communication network 103 that makes use of the location information (e.g., geographical position of a terminal). For example, location-based services (LBS) enable device users to employ the use of geospatial sensors, motion detectors, global positioning technology, near field communication (NFC) protocols and other location tracking tools and approaches to determine a user's node location relative to that of friends, other people or places of interest in real-time. Consequently, location-based services can be used in a variety of contexts, including navigation, entertainment, health, work, personal life, etc. LBS may also be used to facilitate commerce (e.g., trade and repair, wholesale, financial, legal, personal services, business services, communications and media,), ecommerce (e.g., online transactions, coupons, advertising, etc.), or transactions related to hotels, real estate, renting, construction, dining, transport and travel, travel guides, mapping and navigation, parcel/vehicle tracking, personalized weather services, location-based games, etc. Still further, some providers take advantage of LBS within the context of a proof of presence scheme for enabling the activation of user incentives based on a node's determined location at a designated location (e.g., event location 113).

In the context of social networking, LBS may be used implemented in connection with social networking applications to support interaction between friends based on their proximity to one another. This may include the posting or publishing—i.e., the hosting, generating and notifying—of events at given locations 113, such as a party, a sale, a meeting, etc. Unfortunately, current LBS networking services are often static in nature rather than dynamic. Hence, the location information used in connection with the posting of information regarding an event is based on fixed or historic location information. Current systems do not allow the user to regulate the flow of event information based on the dynamically changing proximity of other user's to the event. Furthermore, users are not incented to attract others within the virtual extent of their social network, or even beyond, to events occurring at a given location 113 within proximity of their current whereabouts.

To address this issue, FIG. 1A presents a system that processes location information and information exchanged by one or more wireless nodes 101a-101r regarding a published event. The system 100 includes a location-based event platform 115 that is configured to continually determine location information pertaining to the nodes 101a-101r relative to one another. Location information is provided for each respective node by way of a location-based service module 111a-111r operable at the various nodes 101a-101r. The location-based event platform 115 communicates with the LBS module 111 periodically over the network 103 to invoke the gathering of location information accordingly. This may include, for example, triggering various tracking or sensory mechanisms of the nodes 101a-101r such as global positioning sensors, motion detection sensors, etc. Location information is stored by the platform 115 relative to a given node 101a-101r and subsequently associated with or generated into mapping information 121 for representing geographic locations on a map as it relates to an event or a given user.

Progressive or periodic determining of the location information enables the platform 115 to consistently monitor a distance between the one or more nodes 1011-101r, an event location 113 corresponding to a particular event published by at least one of the users of a node 101, or a combination thereof. When the distance of a node that received event information is determined to within a predetermined proximity of the event location 113 or the node that published the information, platform 115 enables increased/additional event information regarding the event to be published. Conversely, when a node 101 is determined outside of a predetermined proximity of the event location 113 or the node that provided the event information, the amount of event information presented to that node is limited. As noted, this gathered location information may be presented as mapping information 121 for visually representing said distances as well as their variances over time to the map.

FIG. 1B is a diagram of proximity regions for affecting operation of the location-based event platform, according to one embodiment. By way of example, the regions may correspond to an outer region 143 and inner region 141. The outer region 143 is bound by a distance X from a publishing point 151 of a node 101 from which the information is generated, an event location 113 corresponding to the information as published, or a combination thereof. The inner region 141 is bound by a distance Y from the publishing point 151, an event location 113 corresponding to the information as published, or a combination thereof. When a user 161 of a node 101 that receives event information is within the outer region 143 as shown, the amount of event information received is limited as they are located a further distance from the source (publishing point 151) of the information of location of the event 113. As the user travels closer to the publishing point 151, and eventually to within the inner region 141 as shown, the amount of event information is increased. By way of example, as the user walks an elapsed period of time T as represented by the transition arrow towards the source 151 and/or event location 113, the distance is minimized and the location-based event platform 115 enables additional information provided by the source to be transmitted, published and/or otherwise provided to the mobile device of the user 161. It is noted that the publishing point 151 may be synonymous with the event location 113 in certain instances.

Hence, as described above, the location-based event platform 115 regulates the dissemination or flow of event information as generated by at least one of the nodes 101 based on the relative distances of the receiving nodes from the location 1113 or source/publishing point 151. A published event may include, for example, a data object, collection of data objects, or a combination thereof for presenting data that describes or represents an event. The data object may be incorporated or featured (posted) for display to users via a social networking site, website, messaging application, or other application. In certain embodiments, information regarding events is posted to any social interaction platform 107, such as a social networking site, peer-to-peer application or service, chat service, or the like by respective users of wireless nodes 101a-101r. The social interaction platform 107 is accessed by way of an event application 109r, which may be a dedicated application at the nodes 101a-101r for interfacing with a location-based event platform 115, the social interaction platform 107, or a combination thereof. Alternatively, the event application 109a-109r may be a browser or web portal application through which the user may access the social interaction platform 107, location-based event platform 115, or a combination thereof via a network 103.

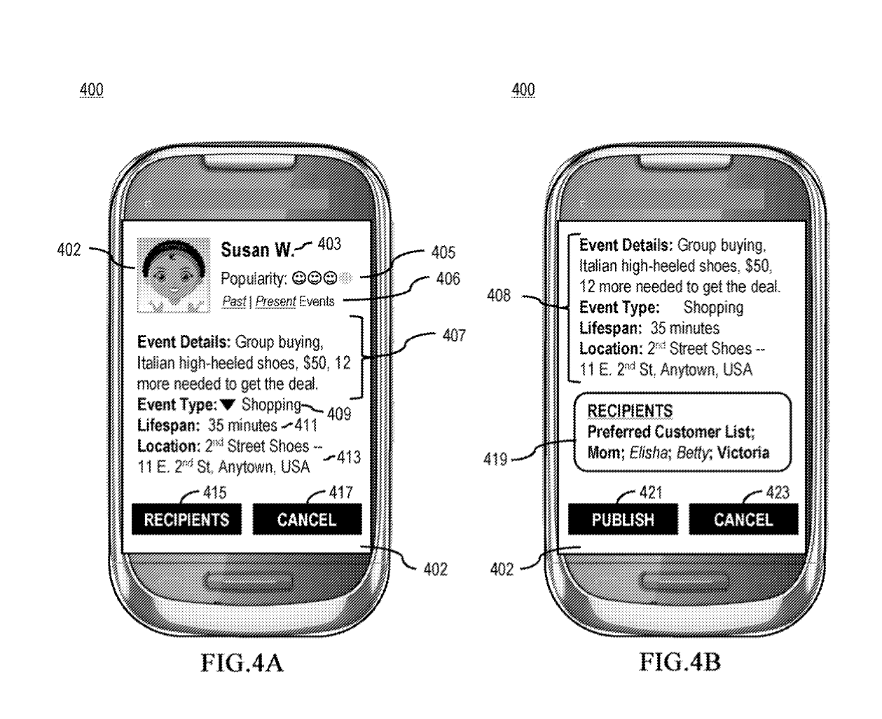

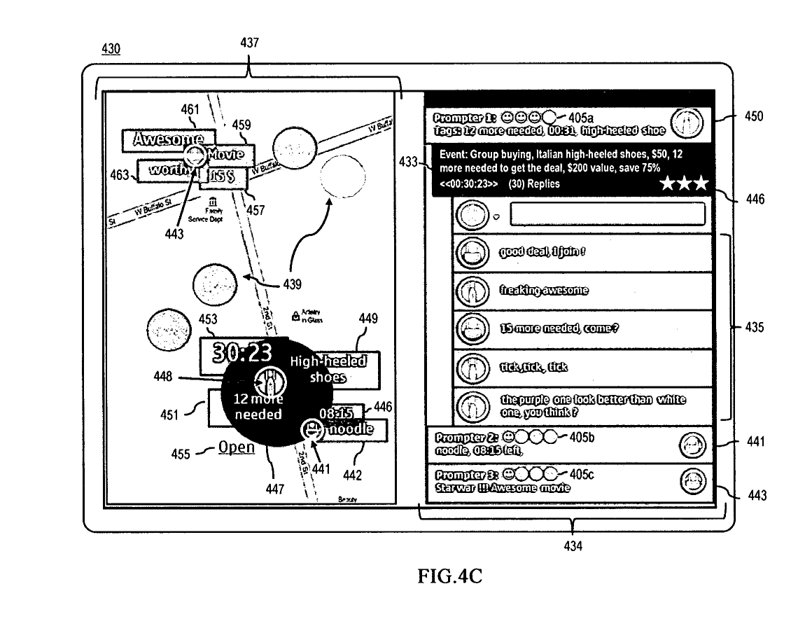

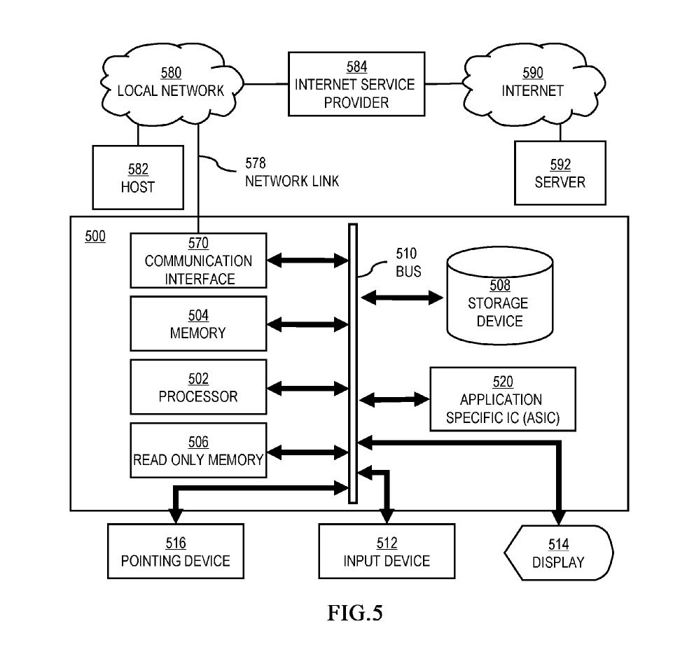

By way of example, when a user of device 101a wishes to post an event regarding a festival occurring within their immediate area, the user may execute the event application 109a to perform one or more of: (1) create a notification message for conveying various details regarding the event, including one or more descriptive or enticing keywords; (2) select one or more other wireless node users from within their virtual network to direct the notification message to; (3) select to post the notification message according to a determined lifespan/life-cycle such that the message is transmitted to the respective one or more other wireless nodes 101n-101r within the extent of the virtual network of the sending user for a duration of time. In addition, the event application 109a of the user may also (4) receive and subsequently display notification messages for conveying event information posted by the other nodes 101; (5) receive and display comment messages provided as responses to prior posted information regarding events, etc.; (6) enable users to search for ongoing events within proximity of their location; (7) find friends or others with similar interests within proximity of their location; (8) receive incentives or status ratings based on interaction with other users surrounding one or more events. One or more control or action buttons are presented for enabling a user to execute these functions as will be described more fully later on with respect to FIGS. 4A-4C.

In exemplary embodiments, the wireless nodes 101a-101n are able to communicate over the network 103 with respect to the platform 115 using local and remote communication techniques given their closer range proximity to one another. Wireless node 101r, however, is also configured to interact with nodes 101a-101n via the platform 115 via remote communication protocols given the greater distance from one another. As discussed more fully later on, the scope or range of communication is based, at least in part, on a virtual extent, range of influence of a node, popularity of a user. The virtual extent may be based, for example, on the quantity of contacts available to the user, the level of access to information regarding the contacts, the number of affiliates or followers associated with the user, and other factors. Hence, the greater the popularity or influence of a user, or popularity of an event, the greater the range of communication and reach available to a user for publishing event.

The communication network 103 is, for instance, a connectionless and serverless device-to-device network (e.g., a mobile ad-hoc network (MANET)) created using short-range radio technology (e.g., wireless local area network (WLAN) or Bluetooth®). Within the network 103, each wireless node 101 may be mobile and is within communication range of any number of other wireless nodes 101. Accordingly, the set of wireless nodes 101a-101r that is within communication range of any a particular wireless node 101 is transient and can change as the wireless nodes 101a-101n move from location to location. It is noted that the ad-hoc radios (e.g., WLAN and Bluetooth®) may be designed to support connectivity (e.g., connectivity via Internet protocol (IP)) among wireless nodes 101 with respect to various applications and services accessible to the device. The applications and services may enable the exchange of awareness information for supporting shared interaction and activity information exchange among the wireless nodes 101a-101r.

The wireless nodes 101a-101r are any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the UE 101 and location-based event platform 115 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

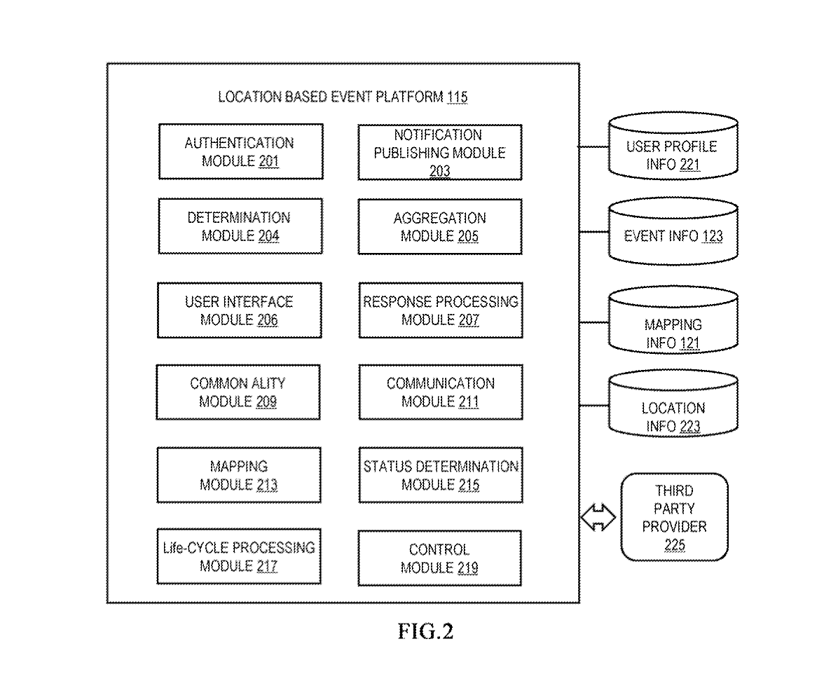

FIG. 2 is a diagram of the components of a location-based event platform, according to one embodiment. By way of example, the location-based event platform 115 includes one or more components for managing the presenting of information related to location-based events. It is contemplated that the functions of these components may be combined in one or more components or performed by other components of equivalent functionality. In this embodiment, the location-based event platform 115 includes an authentication module 201, notification publishing module 203, determination module 204, aggregation module 205, user interface module 206, response processing module 207, commonality module 209, communication module 211, mapping module 213, status determination module 215, lifespan processing module 217 and control module 219.

The platform 115 also maintains various databases, including a user profile information database 221 for storing user profile information, an event information database 123 for storing event information in association with a given user profile, a mapping information database 121 for storing map data representative of a given user's location and a location information database 223 for storing respective user location information. It is noted that the various modules 201-219 may access one or more of the databases for executing its respective functions.

In one embodiment, an authentication module 201 authenticates nodes 101a-101r for interaction with the location-based event platform 115. By way of example, the authentication module 201 receives a request to subscribe to the platform 115, which may be provided by a service provider (e.g., wireless communication provider). Under this scenario, the authentication module 201 verifies and validates a password, user identification, security code or any other value required for enabling access to the event information 123, mapping information 121, location information 223, or a combination thereof with respect to the user. It is noted that the authentication module 201 may access profile information 221 maintained for respective users (subscribers), including the selective recalling, pulling or searching of profile data associated with a given user device that publishes, receives, or responds to event information 123 (e.g., a notification message thereof). Furthermore, the authentication module 121 may enable users to configure access to a social interaction platform 107 or mapping services provider, whether it be a third party service 225 or directly integrated for execution by the location-based event platform 115.

In one embodiment, the notification publishing module 203 enables registered/authenticated users to generate and subsequently publish event information pertaining to one or more location-based events. The notification publishing module 203 interfaces with the event application 109 of respective devices to facilitate generation of one or more notification messages regarding events. Executions of the module 203 may include the establishing of an event, specifying of an event location 113, selection of a specific event type and selecting of a life-cycle for the event. Also, the notification publishing module 203 is configured to associate subsequent event information with an established location-based event.

The determination module 204, in certain embodiments, accesses the LBS modules 111a-111r of the various nodes 101a-101r to receive or generate location information. Based on the determined location information, the module 204 calculates the relative distances between respective wireless nodes 101a-101r, the location of an event 113, or a combination thereof. The determination module 204 is configured to determine whether any of the one or more nodes 101a-101r are within a predetermined proximity suitable for triggering the publishing of additional event information by the notification publishing module 203. For example, when the distance is determined to be decreased, the frequency of publishing or transmission of event information 123 for that node may be increased. Conversely, a greater distance between the node and the event location 113 corresponds to a more limited publishing, transmission or conveyance of event information.

Operating in connection with the determination module 204 is the mapping module 213 and commonality module 209. The mapping module 213 generates mapping information, such as in connection with a third party mapping service 225, based on the determined location information of the various user devices. In addition, the mapping module 213 causes adaptation of the granularity of a map in response to the determined proximity or relative distance between nodes, events or a combination thereof. It is noted that the mapping module 213 may perform in the absence of such as capability by way of the nodes 101.

The commonality module 209 accesses the results of the determination module 204 as well as historic event information 123, user profile information 221, mapping information 121 and location information 223 to identify one or more other users that share common interests, event participation history, user profiles, or the like. For example, the commonality module 209 matches users based on the frequency of them showing up in the same events and/or their tendency to respond to similar events (e.g., similar comments). If allowed by both users, in accordance with a permissions setting, the commonality module 209 generates one or more signals for notifying a user node that another user with similar interests is within proximity of his/her current location.

In one embodiment, the aggregation module 205 aggregates and logs the event information generated by a given user regarding a particular event. This includes aggregation of a first time event posting as well as subsequently generated event information 123. The aggregation module 205 is triggered for operation based, at least in part, on the determined distance, proximity and location information acquired or generated by the determination module 204. By way of example, when the distance of a particular node is determined outside of a predetermined proximity of the event location 113, publishing point (e.g., a prompting user), or a combination thereof, any event information 123 related to a location-based event is stored and prevented from being accessed by the notification publishing module 203. When the proximity of a node is determined to within the predetermined threshold, however, the notification publishing module 203 is permitted to access and convey event information to that node.

In certain embodiments, the aggregation module also maintains historical event information, associated mapping information and location information as a log in connection with a given user profile. As such, the log may be retrieved by the commonality module 209 or status determination module 215 for later processing and analysis in determining common interests between respective device users or in determining a past or present change of influence or popularity of a user, or popularity of an event. It is noted, in certain instances, that the aggregation module 205 may be prompted to not aggregate event information when it is determined that the corresponding life-cycle of an event is negligible; thus preventing and negating the need for the posting of further information related to that location-based event.

In one embodiment, the response processing module 207 receives comment information received from one or more nodes in response to the publishing of event information regarding a location-based event. The module 207 parses the comment information for various words, phrases, graphics or other data based on one or more context processing models, analytic techniques, or the like. In addition, the status determination module 215 determines one or more user specified status indicators, including one or more event or user popularity indicators. Once this data is received, the response processing module then passes it on to a status determination module 215 for analysis.

By way of example, the status determination module 215 determines the number of positive keywords or phrases in one or more received comments, determines the number of responses to an event versus the number of participants, determines the number of favorable ratings versus the number of non-favorable ratings for an event or the user, determines the number of incentives accumulated based on one or more events participated in and other like metrics. Compilation of these metrics enable the module 215 to further determine a level of influence of the user as well as keep track of the popularity of events associated with the user. The influence level is also determined based, at least in part, on a virtual extent of the user's social network.

In certain embodiments, the level of influence of a given user corresponds to a geographic reach of the user for publishing events. Furthermore, the popularity information and/or influence information associated with a given device may determine one or more access rights or sharing rights between nodes. For example, the greater the level of influence as determined by the status determination module 215, the greater is the geographic extent to which the user may reach out to publish events. Hence, certain users may have a limited geographic reach based on their lower determined popularity, while others may have a wider range of influence based on theirs. The level of influence also defines, at least in part, the proximity to which a given user must accommodate in order to receive increased information regarding a posted event. The status determination module 215 periodically calculates the event and user popularity information/levels along with the influence information and associates this data with a respective user profile 221.

In one embodiment, the life-cycle determination module 217 determines and establishes time duration in which one or more location-based events are to remain active. The life-cycle information also impacts the visualization of events and users to a map by the mapping module 213. For example, a reduced life-cycle results in removal of the visualization of the user or event to the map, reduction in the representation of the user or event to the map, or a combination thereof. This duration of time may be established at the discretion of the user, such as in relation to a start and end time for a meeting. In some instances, the life-cycle is established by default by the module 217, i.e., 30 minutes, such as when the user does not specify any event time or date information.

Alternatively, the life-cycle may be adapted dynamically in response to the determined increase or decrease in popularity of an event or user, an increase or decrease in the level of influence of a user, or a combination thereof. By way of example, an additional amount of time may be automatically associated with an event whose comment information, influence information, popularity information, or a combination thereof is high or favorable. Still further, the life-cycle information may be associated with future events and associated locations for enabling the automation of various actions. For example, a user may post an event notification regarding a family event that is to occur next week at a designated time and location (i.e., restaurant). Based on this future event, the life-cycle determination module 217 may operate with the communication module 211 in order to immediately interface with the reservation system of this restaurant. A link to the reservation interface and event details will also be visible to the invited family members as a result of the notification.

Exemplary policies for the provision of additional or reduced time respective to the life-cycle are shown in TABLE 1 below:

TABLE 1
“Positive reply” comment information or “forwarding” of event
notifications (a level of viral intensity) will be represented on the map for
a longer duration and in association with more portions of key event
information (e.g., keywords); “Negative reply” comment
information may result in the restricting/elimination of a duration along,
the reduction in representation on a map, or a natural damping of color
schemes for indicating diminished popularity or influence.
A low response to an event may be represented on the map less visibly
until the user is within the predetermined proximity of the event location
or publishing point
The participation rank of repliers and forwarders may be accounted for in
determining a life-cycle.
Reduce the duration given that frequent success makes subsequent
success more difficult to achieve.
Remove events that are too often buried or over posted from the map.
Get a quick succession of events from “high value” users.
Event publisher and attendee exiting out of range of the event location
diminishes the life-cycle and corresponding event ranking.

It is noted that the life-cycle processing module 217 operates in connection with the mapping module 213 for affecting the visualization of events and users with their respective geographic locations. The life-cycle processing module 217 also operates in connection with a user interface module 206 in certain embodiments. The user interface module 206 enables presentment of data to a graphical user interface of the nodes 101. Various software applications operable by the user device, such as the event application 109, may feature APIs or other function calls corresponding to the user interface module 206 for enabling graphical elements to be rendered to the display. It is noted that in some instances, multiple communication interfaces may be utilized depending on the type of device 101 involved. Moreover, the nodes 101 employ the user interface module 221 to enable control by the user of the device 101 of various communication features during a session.

In one embodiment, a control module 219 is configured to regulate the communication processes between the various modules, including data exchange and timing control where appropriate. The controller module 219 may also facilitate the pushing and pulling of data to and from the various databases 221, 123, 121 and 223 as required for execution of a particular module. Also, the controller module 219 generates the appropriate signals to regulate the communication module 211 for enabling transmission of data between respective nodes 101a-101r and the platform 115 over the communication network 103.

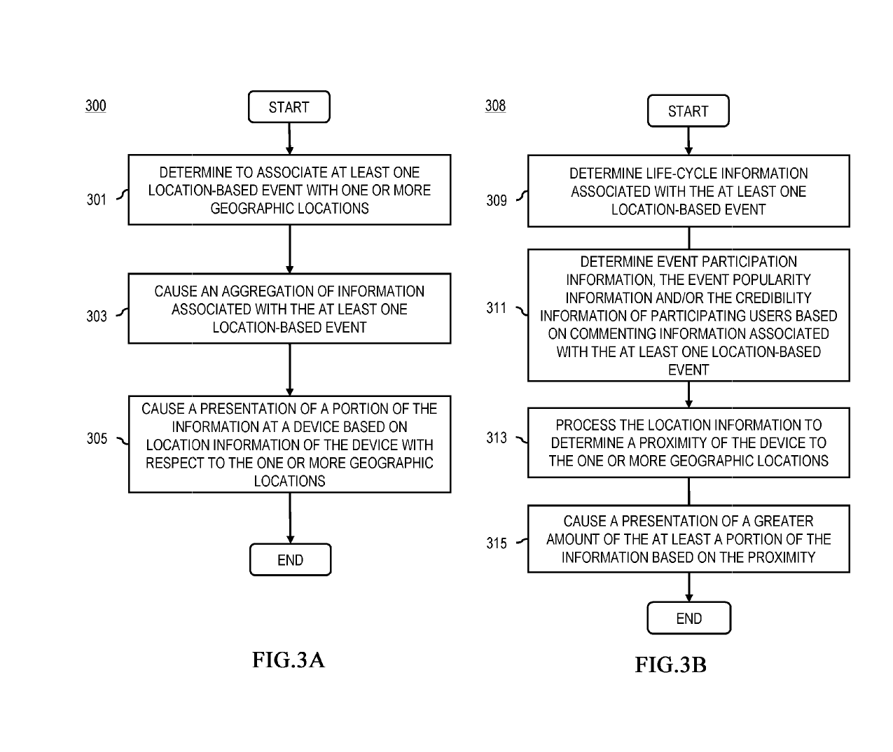

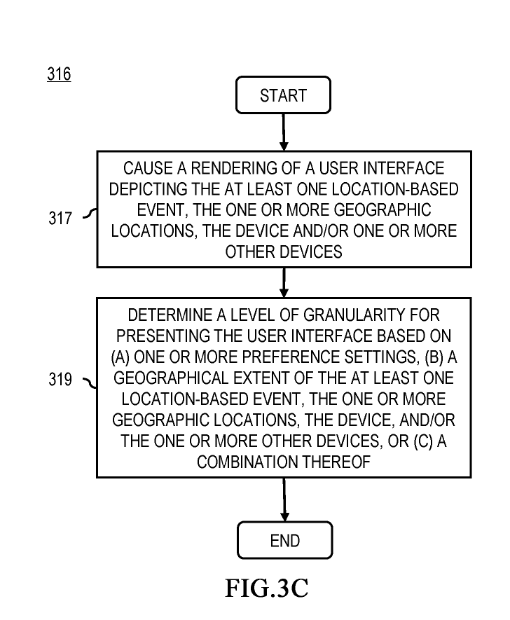

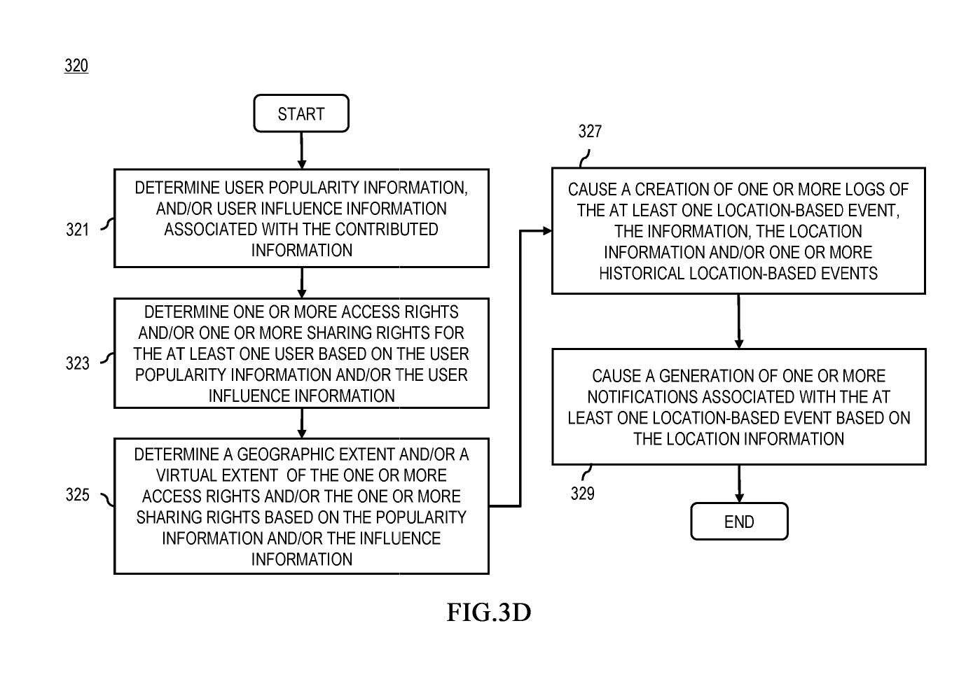

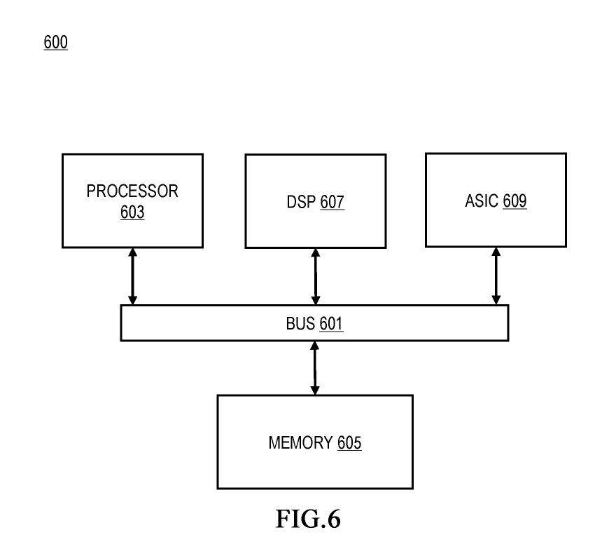

FIGS. 3A-3D are flowcharts of a process for managing the presenting of information related to location-based events, according to various embodiments. In the various embodiments, the location-based event platform 115 performs the process 300 and is implemented in, for instance, a chip set including a processor and a memory as shown in FIG. 6. In step 301, the location-based event platform determines to associate at least one location-based event with one or more geographic locations. As noted previously, this association corresponds to the selecting and indicating of an event location, address information, or a combination thereof in relation to an event. One or more mapping tools may be employed to support automated address lookup based on a provided business name in combination with general territory information (e.g., a zip code or city).

In another step, the platform 115 causes an aggregation of information associated with the at least one location-based event. Hence, as noted previously, the aggregation may be performed in response to determined location information, distance information or proximity information for respective nodes, the location of an event 113, or a combination thereof. Per step 305, the location-based event platform 115 interacts with the event application 109a-109r at each node 101a-101r to which an event was published to cause a presentation of a portion of the information to the nodes 101a-101r. Presentment of the information is based on location information of the device with respect to the one or more geographic locations. The event information, or portions thereof, are presented gradually in response to the determined location of the device.

In step 309 of process 308 (FIG. 3B), the location-based event platform 115 determines life-cycle information associated with the at least one location-based event. In another step 311, the platform 115 also determines event participation information, the event popularity information and/or the credibility information of participating users. As noted previously, the above described status information may be determined based on commenting information associated with the at least one location-based event. By way of example, specific keywords or phrases may be processed according to various language recognition or contextual processing techniques for distinguishing between favorable and unfavorable words.

Per step 313, the platform 115 processes the location information—i.e., as gathered in connection with the one or more LBS modules 111 of respective devices 101—to determine a proximity of the device to the one or more geographic locations. In another step 315, the platform 115 causes a greater amount of the at least a portion of the information based on the proximity. By way of example, a user device within a proximity defined by the inner region 141 of FIG. 1B is permitted to receive more event information than a user device within the outer region 143.

In step 317 of process 316 (FIG. 3C), the location-based event platform 115 operates in connection with the event application at respective devices to cause a rendering of a user interface depicting the at least one location-based event, the one or more geographic locations, the device and/or one or more other device. As noted previously, this may include the rending of the above described event information to a map or in connection with a social interaction service 113. Per step 319, a level of granularity for presenting the user interface is determined. The determination may be based on one or more factors, including for example: (a) one or more preference settings, (b) a geographical extent of the at least one location-based event, the one or more geographic locations, the device, and/or the one or more other devices, or (c) a combination thereof. It is noted that the geographical extent may correspond to the level of influence of the user, the size of their social network, and other factors. Also, in certain embodiments, the level of granularity may correspond to time related data—i.e., aggregation of event information may also be needed for visually representing the information. For example, a user interested in purchasing a home at a given location can retrieve information regarding the neighborhood, i.e., the number of reported criminal incidents, by year, quarter, month, time of day, etc.

In step 321 of process 320 (FIG. 3D), the location-based event platform 321 determines user popularity and/or influence information associated with the contributed event related information. In another step 323, the platform 321 also determines one or more access rights and/or one or more sharing rights for at least one user based on the user popularity information and/or the influence information. In certain embodiments, the access rights pertain to the ability of a given device user to make contact with another user for engaging in the sharing of information related to location-based events. Also, the access rights or sharing rights may correspond to an extent of geographic reach of a user for enabling the generating, publishing and subsequent transmission of location-based events and information thereof. This corresponds to step 325, wherein the platform 115 determines a geographic extent and/or a virtual extent of the one or more access rights and/or sharing rights. It is noted that this determination may be based, at least in part, on a level of popularity or influence of the user to which the rights are to be granted.

By way of example, a scenario involving two users is presented. The two users are both employed at the same financial services firm and wish to host separate location-based events related to the promotion of mutual funds and other financial products. The first device user is a Regional Vice President of the firm, having responsibility over a territory of offices and hundreds of representatives, while the other user is a representative that works out of a particular office. Under this scenario, the first user may have a higher level of influence and popularity than the representative for various reasons, including for example: the title, role and level of responsibility difference between the two users and the historical popularity ranking difference between the users. In addition, the level of influence of the first user may be based on the virtual extent—i.e., vastness of the user's social network. The size of the first user's contact list may be larger than that of the second user's due to the expanse of the first user's territorial engagement. Consequently, the first user may be able access a broader array of clients and other individuals for which to contact regarding the seminar as well as increased access to company contacts, resources and information based on access rights.

In step 327, the platform 115 causes a creation of one or more logs of the at least one location-based event, the information related thereto, the location information and/or one or more historical location-based events. As noted previously, the logs may be maintained by the platform 115 for subsequent analysis, including for determining changes in popularity of a user, changes in popularity of a specific event or venue, changes in influence of a use, etc. In addition, the logs may be accessed by one or more advertisers, merchants, study groups, researches, etc., for observing an extent of response to a given incentive, promotion or advertising campaign. The information may be further associated with one or more websites, data resources or the like for activation in connection with the retrieval of event information via an event application 109.

Per step 329, the location-based event platform 115 causes a generation of one or more notifications associated with the at least one location-based event. The notification may be generated in the form of a message, an alert, or other indicator for signaling the availability of information related to an event based on location information. As noted, the notifications may be triggered in response to a determined change in proximity of a given device to an event location or publishing point. In certain embodiments, it is contemplated that the notifications may vary in frequency or intensity proportionate to the decrease in distance between a device to receive the notification and the location of the event or publisher of the event.

FIGS. 4A-4C are diagrams of user interfaces utilized in the processes of FIG. 3, according to various embodiments. For example, purposes, the diagrams are presented from the perspective of a device user that is a store manager (Susan W.) at 2^{nd} Street shoes establishing a location-based event regarding a shoe sale. Under this scenario, the store manager's company issued mobile device 400 represents the publishing point while the store is the publishing point and the event location. It is noted that the event location may also be associated with a particular device for transmission of event information via the location-based event platform 115.

In order to establish the sales event with respect to the store location, the store manager launches the event application of her mobile device phone. This may include providing a login identifier, password for accessing the event application as a representative of the store and other security measures. By logging in as a representative of the store, the store manager is able to access proprietary store information and resources, including the customer contact list, preferred client contact information, etc.

The display 402 is caused to present various data entry fields, information, and other details for enabling the user to publish an event notification and associated event information. By way of example, an avatar 402 representing the store manager is shown along with the name of the store manager based on login. A popularity indicator 405 is also shown for indicating the popularity of the user, which in this example is represented by a number of “Smileys” on a best out of four scale. Selection of the past events corresponds to accessing of the event information logs as maintained by the platform 115 in relation to the user or the store. Selection of the present event corresponds to accessing of a listing of current events to which one or more event notification messages are associated.

The manager configures various event details 407, using as many enticing words as possible to drive individuals to the sales event at the store. In addition, she enters the event type 409, a suggested lifespan 411 of the sales event, and the corresponding location of the event 413. It is noted that the keywords and phrases entered by the manager are analyzed by the location-based event platform for presentment accordingly—i.e., presenting only the most relevant, popular, enticing, or thematic words and phrases in connection with an event. Furthermore, the location information is entered by way of the business name of the store, the postal address of the store, or a combination thereof.

Having configured various details regarding the sales event, the user can select a “CANCEL” action button 417 to cancel the establishing of an event notification regarding the location-based event. Selection of the “RECIPIENTS” action button 415, however, results in the rendering of a recipient selection list to the display, as shown in FIG. 4B. The recipient selection list 419 enables the manager to select one or more other device users that are to receive the event notification regarding the sales event. The number of contacts, ability to access certain contacts (e.g., Preferred Customer List) and other permissions directly relate to the managers influence level. In this example, the manager selects a group representing preferred customers, her mother and a few friends. In certain embodiments, the location-based event platform 115 may suggest one or more recipients to add to the list 419. It may also provide one or more indications of when a given user selected as a recipient is in or out of proximity for receiving all of the event notifications.

In addition to the list, an event detail summary 408 is presented for enabling the manager to review the event information another time prior to transmission/publication. Once verified, the manager then select to post the event by selecting the “PUBLISH” action button 421 or cancel the process by selecting the “CANCEL” action button 423. Selection of the “PUBLISH” action button 421 causes transmission of the captured event detail summary data 408 for processing by the platform 115.

The display of a device belonging to at least one or the recipients is shown with respect to FIG. 4C. The display comprises at least two sections, namely a map representation 437 and an event interaction section 434. Several of the information presented with respect to the event interaction section 435 is presented or represented accordingly in the map representation 437. By way of example, the interface presents a prompter notification section 450, 441 and 443. The prompter notification section 450, 441 and 443 presents the name of the prompter, a summarized description of the event the prompter is promoting, an emoticon for representing an expression or sentiment of the prompter, a popularity rating 405a associated with the user, etc. Upon selecting a particular prompter notification section, such as section 450, an expanded or collapsed view of the associated event information relating to that prompter is caused to be rendered to the display of the device 430. For example purposes, prompter 1 is synonymous with the manager (Susan W.). Alternatively, selection of an “Open” link 455 from the map representation 437 may also be activated for enabling the collapsed view in the event interaction section 434.

The collapsed view reveals an ongoing message thread 435 representing a social interaction between the prompter and one or more of the recipients. In addition, the collapsed view also features an event descriptor 433 for providing specific details regarding the event. It is observed, for example, that the event descriptor includes the various keywords and phrases specified initially by the prompter. In addition, the life-cycle information pertaining to the event is shown along with the number of replies received in response to the event notification by prompter 1. A star ranking 446 is also presented for indicating the level of influence of the prompter (Susan W.) relative to the popularity of the event, the number of responses received, the number of positive keywords and/or phrases, or a combination thereof.

The map representation 437 presents one or more icons 441, 443 and 448 for representing a geographic location of the prompter and other users relative to one another, and relative to one or more events they have published. By way of example, in addition to the sales event as generated by prompter 1 (Susan W.), prompter 2 published an event regarding a noodle shop at which he is currently eating. In addition, a third prompter posts an event regarding a movie they are enjoying at the moment. Several of the keywords and phrases conveyed in the prompt notification sections 450, 441 and 443 are presented as portions of event information in the map relative to the user's respective locations on the map. By way of example, portions 449, 451 and 453 are presented with respect to prompter 1 for indicating the most appealing or descriptive information about the event “High-heeled shoes,” the number of people needed to activate the discount, and the current life-cycle of the sales event.

Similarly, for prompter 2, portions of event information 442 and 446 are presented to the display, while for prompter 3 portions 457-463 are shown. As mentioned previously, the respective portions of information presented are based on numerous considerations, including an assessment of what is the most enticing or relevant information to reveal. By way of example, the portion of event information 449 and 451 shown with respect to prompter 1 is “High-heeled shoes” and “12 more needed.” This particular event information is presented based on a determination that this information is most relevant, useful, insightful, enticing or helpful for describing the sales event. Also, the information is gradually presented as opposed to all at once depending on the proximity of the recipient. Hence, as the distance between the recipient and the event location lessens, additional event information is posted for review in relation to the geographic location of the event or prompter on the map, i.e., based on location information.

It is noted that the popularity of the respective users (prompters 1-3) interacting via the location-based event platform 115 is also represented on the map representation 437. For example, because prompter 1 has the highest popularity ranking 405a, this user is shown on the map as having a greater circle of influence 447. This greater influence level may also correspond to a greater geographic reach of the prompter. As the number of positive comment information, popularity ratings, influence ratings, or incentives associated with the user grows, the circle of influence may change dynamically for representation to the map. Conversely, prompter 2 and 3 have lower popularity rankings and are therefore shown without any particular influence indicator (e.g., a circle of influence 447). The addition of more positive responses or attendees to their events, however, can result in dynamic updating of the popularity rankings 405b and 405c accordingly. It is noted that the depiction of influence in the form of a circle, as shown in the map representation, may be performed in other ways, including through the use of icons, color schemes, textual references, etc.

Still further, one or more other users 439 may be presented to the map and interacted with via the location-based service platform 115. In certain embodiments, one or more notification messages may be presented for indicating that a device user having similar interests or characteristics are within proximity of one another, the event, or the prompter. Under this approach, the location based event platform 115 enables the cross referencing of user profile information, event information, location information and map information for determining similarities or potential matches.

The processes described herein for managing the presenting of information related to location-based events may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

FIG. 5 illustrates a computer system 500 upon which an embodiment of the invention may be implemented. Although computer system 500 is depicted with respect to a particular device or equipment, it is contemplated that other devices or equipment (e.g., network elements, servers, etc.) within FIG. 5 can deploy the illustrated hardware and components of system 500. Computer system 500 is programmed (e.g., via computer program code or instructions) to manage the presenting of information related to location-based events as described herein and includes a communication mechanism such as a bus 510 for passing information between other internal and external components of the computer system 500. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 500, or a portion thereof, constitutes a means for performing one or more steps of managing the presenting of information related to location-based events.

A bus 510 includes one or more parallel conductors of information so that information is transferred quickly among devices coupled to the bus 510. One or more processors 502 for processing information are coupled with the bus 510.

A processor (or multiple processors) 502 performs a set of operations on information as specified by computer program code related to manage the presenting of information related to location-based events. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 510 and placing information on the bus 510. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 502, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 500 also includes a memory 504 coupled to bus 510. The memory 504, such as a random access memory (RAM) or any other dynamic storage device, stores information including processor instructions for managing the presenting of information related to location-based events. Dynamic memory allows information stored therein to be changed by the computer system 500. RAM allows a unit of information stored at a location called a memory address to be stored and retrieved independently of information at neighboring addresses. The memory 504 is also used by the processor 502 to store temporary values during execution of processor instructions. The computer system 500 also includes a read only memory (ROM) 506 or any other static storage device coupled to the bus 510 for storing static information, including instructions, that is not changed by the computer system 500. Some memory is composed of volatile storage that loses the information stored thereon when power is lost. Also coupled to bus 510 is a non-volatile (persistent) storage device 508, such as a magnetic disk, optical disk or flash card, for storing information, including instructions, that persists even when the computer system 500 is turned off or otherwise loses power.

Information, including instructions for managing the presenting of information related to location-based events, is provided to the bus 510 for use by the processor from an external input device 512, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 500. Other external devices coupled to bus 510, used primarily for interacting with humans, include a display device 514, such as a cathode ray tube (CRT), a liquid crystal display (LCD), a light emitting diode (LED) display, an organic LED (OLED) display, a plasma screen, or a printer for presenting text or images, and a pointing device 516, such as a mouse, a trackball, cursor direction keys, or a motion sensor, for controlling a position of a small cursor image presented on the display 514 and issuing commands associated with graphical elements presented on the display 514. In some embodiments, for example, in embodiments in which the computer system 500 performs all functions automatically without human input, one or more of external input device 512, display device 514 and pointing device 516 is omitted.

In the illustrated embodiment, special purpose hardware, such as an application specific integrated circuit (ASIC) 520, is coupled to bus 510. The special purpose hardware is configured to perform operations not performed by processor 502 quickly enough for special purposes. Examples of ASICs include graphics accelerator cards for generating images for display 514, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 500 also includes one or more instances of a communications interface 570 coupled to bus 510. Communication interface 570 provides a one-way or two-way communication coupling to a variety of external devices that operate with their own processors, such as printers, scanners and external disks. In general the coupling is with a network link 578 that is connected to a local network 580 to which a variety of external devices with their own processors are connected. For example, communication interface 570 may be a parallel port or a serial port or a universal serial bus (USB) port on a personal computer. In some embodiments, communications interface 570 is an integrated services digital network (ISDN) card or a digital subscriber line (DSL) card or a telephone modem that provides an information communication connection to a corresponding type of telephone line. In some embodiments, a communication interface 570 is a cable modem that converts signals on bus 510 into signals for a communication connection over a coaxial cable or into optical signals for a communication connection over a fiber optic cable. As another example, communications interface 570 may be a local area network (LAN) card to provide a data communication connection to a compatible LAN, such as Ethernet. Wireless links may also be implemented. For wireless links, the communications interface 570 sends or receives or both sends and receives electrical, acoustic or electromagnetic signals, including infrared and optical signals that carry information streams, such as digital data. For example, in wireless handheld devices, such as mobile telephones like cell phones, the communications interface 570 includes a radio band electromagnetic transmitter and receiver called a radio transceiver. In certain embodiments, the communications interface 570 enables connection to the communication network 105 for managing the presenting of information related to location-based events to the UE 101.

The term “computer-readable medium” as used herein refers to any medium that participates in providing information to processor 502, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 508. Volatile media include, for example, dynamic memory 504. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 520.

Network link 578 typically provides information communication using transmission media through one or more networks to other devices that use or process the information. For example, network link 578 may provide a connection through local network 580 to a host computer 582 or to equipment 584 operated by an Internet Service Provider (ISP). ISP equipment 584 in turn provides data communication services through the public, world-wide packet-switching communication network of networks now commonly referred to as the Internet 590.

A computer called a server host 592 connected to the Internet hosts a process that provides a service in response to information received over the Internet. For example, server host 592 hosts a process that provides information representing video data for presentation at display 514. It is contemplated that the components of system 500 can be deployed in various configurations within other computer systems, e.g., host 582 and server 592.

At least some embodiments of the invention are related to the use of computer system 500 for implementing some or all of the techniques described herein. According to one embodiment of the invention, those techniques are performed by computer system 500 in response to processor 502 executing one or more sequences of one or more processor instructions contained in memory 504. Such instructions, also called computer instructions, software and program code, may be read into memory 504 from another computer-readable medium such as storage device 508 or network link 578. Execution of the sequences of instructions contained in memory 504 causes processor 502 to perform one or more of the method steps described herein. In alternative embodiments, hardware, such as ASIC 520, may be used in place of or in combination with software to implement the invention. Thus, embodiments of the invention are not limited to any specific combination of hardware and software, unless otherwise explicitly stated herein.

The signals transmitted over network link 578 and other networks through communications interface 570, carry information to and from computer system 500. Computer system 500 can send and receive information, including program code, through the networks 580, 590 among others, through network link 578 and communications interface 570. In an example using the Internet 590, a server host 592 transmits program code for a particular application, requested by a message sent from computer 500, through Internet 590, ISP equipment 584, local network 580 and communications interface 570. The received code may be executed by processor 502 as it is received, or may be stored in memory 504 or in storage device 508 or any other non-volatile storage for later execution, or both. In this manner, computer system 500 may obtain application program code in the form of signals on a carrier wave.

Various forms of computer readable media may be involved in carrying one or more sequence of instructions or data or both to processor 502 for execution. For example, instructions and data may initially be carried on a magnetic disk of a remote computer such as host 582. The remote computer loads the instructions and data into its dynamic memory and sends the instructions and data over a telephone line using a modem. A modem local to the computer system 500 receives the instructions and data on a telephone line and uses an infra-red transmitter to convert the instructions and data to a signal on an infra-red carrier wave serving as the network link 578. An infrared detector serving as communications interface 570 receives the instructions and data carried in the infrared signal and places information representing the instructions and data onto bus 510. Bus 510 carries the information to memory 504 from which processor 502 retrieves and executes the instructions using some of the data sent with the instructions. The instructions and data received in memory 504 may optionally be stored on storage device 508, either before or after execution by the processor 502.

FIG. 6 illustrates a chip set or chip 600 upon which an embodiment of the invention may be implemented. Chip set 600 is programmed to manage the presenting of information related to location-based events as described herein and includes, for instance, the processor and memory components described with respect to FIG. 5 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 600 can be implemented in a single chip. It is further contemplated that in certain embodiments the chip set or chip 600 can be implemented as a single “system on a chip.” It is further contemplated that in certain embodiments a separate ASIC would not be used, for example, and that all relevant functions as disclosed herein would be performed by a processor or processors. Chip set or chip 600, or a portion thereof, constitutes a means for performing one or more steps of providing user interface navigation information associated with the availability of functions. Chip set or chip 600, or a portion thereof, constitutes a means for performing one or more steps of managing the presenting of information related to location-based events.

In one embodiment, the chip set or chip 600 includes a communication mechanism such as a bus 601 for passing information among the components of the chip set 600. A processor 603 has connectivity to the bus 601 to execute instructions and process information stored in, for example, a memory 605. The processor 603 may include one or more processing cores with each core configured to perform independently. A multi-core processor enables multiprocessing within a single physical package. Examples of a multi-core processor include two, four, eight, or greater numbers of processing cores. Alternatively or in addition, the processor 603 may include one or more microprocessors configured in tandem via the bus 601 to enable independent execution of instructions, pipelining, and multithreading. The processor 603 may also be accompanied with one or more specialized components to perform certain processing functions and tasks such as one or more digital signal processors (DSP) 607, or one or more application-specific integrated circuits (ASIC) 609. A DSP 607 typically is configured to process real-world signals (e.g., sound) in real time independently of the processor 603. Similarly, an ASIC 609 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 600 includes merely one or more processors and some software and/or firmware supporting and/or relating to and/or for the one or more processors.

The processor 603 and accompanying components have connectivity to the memory 605 via the bus 601. The memory 605 includes both dynamic memory (e.g., RAM, magnetic disk, writable optical disk, etc.) and static memory (e.g., ROM, CD-ROM, etc.) for storing executable instructions that when executed perform the inventive steps described herein to manage the presenting of information related to location-based events. The memory 605 also stores the data associated with or generated by the execution of the inventive steps.

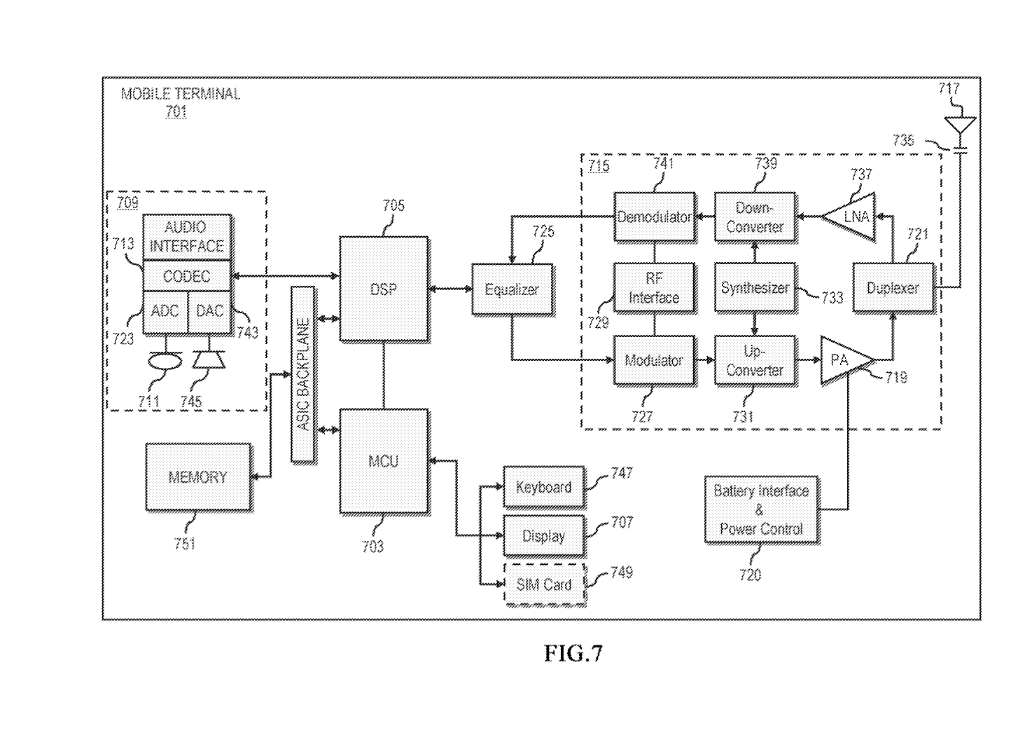

FIG. 7 is a diagram of exemplary components of a mobile terminal (e.g., handset) for communications, which is capable of operating in the system of FIG. 1, according to one embodiment. In some embodiments, mobile terminal 701, or a portion thereof, constitutes a means for performing one or more steps of managing the presenting of information related to location-based events. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 703, a Digital Signal Processor (DSP) 705, and a receiver/transmitter unit including a microphone gain control unit and a speaker gain control unit. A main display unit 707 provides a display to the user in support of various applications and mobile terminal functions that perform or support the steps of managing the presenting of information related to location-based events. The display 707 includes display circuitry configured to display at least a portion of a user interface of the mobile terminal (e.g., mobile telephone). Additionally, the display 707 and display circuitry are configured to facilitate user control of at least some functions of the mobile terminal. An audio function circuitry 709 includes a microphone 711 and microphone amplifier that amplifies the speech signal output from the microphone 711. The amplified speech signal output from the microphone 711 is fed to a coder/decoder (CODEC) 713.

A radio section 715 amplifies power and converts frequency in order to communicate with a base station, which is included in a mobile communication system, via antenna 717. The power amplifier (PA) 719 and the transmitter/modulation circuitry are operationally responsive to the MCU 703, with an output from the PA 719 coupled to the duplexer 721 or circulator or antenna switch, as known in the art. The PA 719 also couples to a battery interface and power control unit 720.

In use, a user of mobile terminal 701 speaks into the microphone 711 and his or her voice along with any detected background noise is converted into an analog voltage. The analog voltage is then converted into a digital signal through the Analog to Digital Converter (ADC) 723. The control unit 703 routes the digital signal into the DSP 705 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 725 for compensation of any frequency-dependent impairments that occur during transmission though the air such as phase and amplitude distortion. After equalizing the bit stream, the modulator 727 combines the signal with a RF signal generated in the RF interface 729. The modulator 727 generates a sine wave by way of frequency or phase modulation. In order to prepare the signal for transmission, an up-converter 731 combines the sine wave output from the modulator 727 with another sine wave generated by a synthesizer 733 to achieve the desired frequency of transmission. The signal is then sent through a PA 719 to increase the signal to an appropriate power level. In practical systems, the PA 719 acts as a variable gain amplifier whose gain is controlled by the DSP 705 from information received from a network base station. The signal is then filtered within the duplexer 721 and optionally sent to an antenna coupler 735 to match impedances to provide maximum power transfer. Finally, the signal is transmitted via antenna 717 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 701 are received via antenna 717 and immediately amplified by a low noise amplifier (LNA) 737. A down-converter 739 lowers the carrier frequency while the demodulator 741 strips away the RF leaving only a digital bit stream. The signal then goes through the equalizer 725 and is processed by the DSP 705. A Digital to Analog Converter (DAC) 743 converts the signal and the resulting output is transmitted to the user through the speaker 745, all under control of a Main Control Unit (MCU) 703 which can be implemented as a Central Processing Unit (CPU).

The MCU 703 receives various signals including input signals from the keyboard 747. The keyboard 747 and/or the MCU 703 in combination with other user input components (e.g., the microphone 711) comprise a user interface circuitry for managing user input. The MCU 703 runs a user interface software to facilitate user control of at least some functions of the mobile terminal 701 to manage the presenting of information related to location-based events. The MCU 703 also delivers a display command and a switch command to the display 707 and to the speech output switching controller, respectively. Further, the MCU 703 exchanges information with the DSP 705 and can access an optionally incorporated SIM card 749 and a memory 751. In addition, the MCU 703 executes various control functions required of the terminal. The DSP 705 may, depending upon the implementation, perform any of a variety of conventional digital processing functions on the voice signals. Additionally, DSP 705 determines the background noise level of the local environment from the signals detected by microphone 711 and sets the gain of microphone 711 to a level selected to compensate for the natural tendency of the user of the mobile terminal 701.

The CODEC 713 includes the ADC 723 and DAC 743. The memory 751 stores various data including call incoming tone data and is capable of storing other data including music data received via, e.g., the global Internet. The software module could reside in RAM memory, flash memory, registers, or any other form of writable storage medium known in the art. The memory device 751 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 749 carries, for instance, important information, such as the cellular phone number, the carrier supplying service, subscription details, and security information. The SIM card 749 serves primarily to identify the mobile terminal 701 on a radio network. The card 749 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1-44. (canceled)

45. A method comprising facilitating a processing of and/or processing (1) data and/or (2) information and/or (3) at least one signal, the (1) data and/or (2) information and/or (3) at least one signal based, at least in part, on the following:
at least one determination to associate at least one location-based event with one or more geographic locations;
an aggregation of information associated with the at least one location-based event; and
a presentation of at least a portion of the information at a device, based at least in part, on location information of the device with respect to the one or more geographic locations.

46. A method of claim 45, wherein the presentation is a gradual presentation of the at least a portion of the information based, at least in part, on the location information of the device.

47. A method of claim 46, wherein the (1) data and/or (2) information and/or (3) at least one signal are further based, at least in part, on the following:
a processing of the location information to determine a proximity of the device to the one or more geographic locations; and
a presentation of a greater amount of the at least a portion of the information based, at least in part, on the proximity.

48. A method of claim 45, wherein the (1) data and/or (2) information and/or (3) at least one signal are further based, at least in part, on the following:
at least one determination of life-cycle information associated with the at least one location-based event,
wherein the aggregation of the information, the presentation of the at least a portion of the information, or a combination thereof is based, at least in part, on the life-cycle information.

49. A method of claim 48, wherein the life-cycle information is based, at least in part, on at least one predetermined duration, event participation information, event popularity information, credibility information of participating users, or a combination thereof.

50. A method of claim 49, wherein the (1) data and/or (2) information and/or (3) at least one signal are further based, at least in part, on the following:
at least one determination of the event participation information, the event popularity information, the credibility information of participating users, or a combination thereof based, at least in part, on commenting information associated with the at least one location-based event.

51. A method of claim 45, wherein the (1) data and/or (2) information and/or (3) at least one signal are further based, at least in part, on the following:
a rendering of a user interface depicting the at least one location-based event, the one or more geographic locations, the device, one or more other devices, or a combination thereof,
wherein the user interface is based, at least in part, on one or more mapping services, one or more navigation services, one or more location-based services, or a combination thereof.

52. A method of claim 51, wherein the (1) data and/or (2) information and/or (3) at least one signal are further based, at least in part, on the following:
at least one determination of a level of granularity for presenting the user interface based, at least in part, on one or more preference settings, a geographical extent of the at least one location-based event, the one or more geographic locations, the device, the one or more other devices, or a combination thereof.

53. A method of claim 45, wherein the (1) data and/or (2) information and/or (3) at least one signal are further based, at least in part, on the following, wherein the information includes, at least in part, contributed information from at least one user, the method further comprising:
at least one determination of user popularity information, user influence information, or a combination thereof associated with the contributed information; and
at least one determination of one or more access rights, one or more sharing rights, or a combination thereof for the at least one user based, at least in part, on the user popularity information, the user influence information, or a combination thereof.

54. An apparatus comprising:
at least one processor; and
at least one memory including computer program code for one or more programs,
the at least one memory and the computer program code configured to, with the at least one processor, cause the apparatus to perform at least the following,
determine to associate at least one location-based event with one or more geographic locations;
cause, at least in part, an aggregation of information associated with the at least one location-based event; and
cause, at least in part, a presentation of at least a portion of the information at a device, based at least in part, on location information of the device with respect to the one or more geographic locations.

55. An apparatus of claim 54, wherein the presentation is a gradual presentation of the at least a portion of the information based, at least in part, on the location information of the device.

56. An apparatus of claim 55, wherein the apparatus is further caused to:
process and/or facilitate a processing of the location information to determine a proximity of the device to the one or more geographic locations; and
cause, at least in part, a presentation of a greater amount of the at least a portion of the information based, at least in part, on the proximity.

57. An apparatus of claim 54, wherein the apparatus is further caused to:
determine life-cycle information associated with the at least one location-based event,
wherein the aggregation of the information, the presentation of the at least a portion of the information, or a combination thereof is based, at least in part, on the life-cycle information.

58. An apparatus of claim 57, wherein the life-cycle information is based, at least in part, on at least one predetermined duration, event participation information, event popularity information, credibility information of participating users, or a combination thereof.

59. An apparatus of claim 58, wherein the apparatus is further caused to:
determine the event participation information, the event popularity information, the credibility information of participating users, or a combination thereof based, at least in part, on commenting information associated with the at least one location-based event.

60. An apparatus of claim 54, wherein the apparatus is further caused to:
cause, at least in part, a rendering of a user interface depicting the at least one location-based event, the one or more geographic locations, the device, one or more other devices, or a combination thereof,
wherein the user interface is based, at least in part, on one or more mapping services, one or more navigation services, one or more location-based services, or a combination thereof.

61. An apparatus of claim 60, wherein the apparatus is further caused to:
determine a level of granularity for presenting the user interface based, at least in part, on one or more preference settings, a geographical extent of the at least one location-based event, the one or more geographic locations, the device, the one or more other devices, or a combination thereof.

62. An apparatus of claim 54, wherein the information includes, at least in part, contributed information from at least one user, the method further comprising:
determine user popularity information, user influence information, or a combination thereof associated with the contributed information; and
determine one or more access rights, one or more sharing rights, or a combination thereof for the at least one user based, at least in part, on the user popularity information, the user influence information, or a combination thereof.

63. A computer program product including one or more sequences of one or more instructions which, when executed by one or more processors, cause an apparatus to at least perform the steps:
determining to associate at least one location-based event with one or more geographic locations;
causing, at least in part, an aggregation of information associated with the at least one location-based event; and
causing, at least in part, a presentation of at least a portion of the information at a device, based at least in part, on location information of the device with respect to the one or more geographic locations.

64. A computer program product of claim 63, wherein the presentation is a gradual presentation of the at least a portion of the information based, at least in part, on the location information of the device.
